(19) United States
(12) Patent Application Publication
(10) Pub. No.: US 2005/0004719 A1
(43) Pub. Date: Jan. 6, 2005

(54) Device and method for determining the position of objects in the surroundings of a motor vehicle

(75) Inventors: Juergen Dickmann, Ulm (DE); Moheb Mekhaiel, Neu-Ulm (DE); Michael Skutek, Ulm (DE)

Correspondence Address: DAVIDSON, DAVIDSON & KAPPEL, LLC, 485 SEVENTH AVENUE, 14TH FLOOR, NEW YORK, NY, 10018, US

(73) Assignee: DaimlerChrysler AG, Stuttgart (DE)

(21) Appl. No.: 10/859,790

(22) Filed: Jun. 3, 2004

(30) Foreign Application Priority Data
Jun. 10, 2003 (DE) DE103 26 431.0-55

(51) Int. Cl. G06F 7/00

(52) U.S. Cl. 701/1

(57) ABSTRACT

A method for sensing objects in the surrounding field of vehicles, input values being determined by a plurality of sensors, and positional information pertaining to the objects being derived on the basis of a comparison with stored data, as well as a device for implementing the method.

This claims the benefit of German Patent Application No 103 26 431.0-55, filed Jun. 10, 2003 and hereby incorporated by reference herein.

The present invention is directed to a device and to a method for determining the position of objects in the surroundings of a motor vehicle.

### BACKGROUND

Due to the tremendous increase in traffic density over the last decades and the elevated risk of accidents associated therewith, systems for improving vehicle safety have gained in importance.

The focus of engineering and development has been, in particular, in the area of safety systems, which are activated in the event of a collision with an obstacle or another vehicle. In the meantime, airbags and seat-belt tighteners have become standard safety equipment in virtually every production vehicle. In order for these components to be optimally effective, first measures are advantageously initiated, not only at the time of or immediately following the moment of impact, but already beforehand. Such measures include, for example, resetting the electronic control of a seat-belt tightener or airbag to a state of heightened readiness.

To this end, it is necessary, however, to reliably predict the imminent accident event already before the instant of impact.

Therefore, information must be obtained on the positions and relative velocities of objects in the relatively near vehicle surroundings.

Moreover, this information can be used to realize additional functionalities, such as a park distance control, a monitoring of the dead angle, as well as a stop-and-go assistant, in addition to an electronic distance control, such as an adaptive cruise control (ACC) in the vehicle.

One possible approach for monitoring the vehicle surroundings provides for using radar sensors.

Thus, for example, the SAE paper 1999-01-1239 _{“}Radar Based Near Distance Sensing Device for Automotive Application”, describes a surrounding-field sensor system based on the use of radars. The system described in the mentioned publication employs two radar sensors, which work in a frequency range of 24 GHz and cover the area in front of the vehicle front end and, respectively, behind the rear-end section. Since the radar modules used in the described publication do not exhibit any directivity characteristic, the precise position of a sensed object is determined from the measured distances using triangulation. This requires that an object, whose precise position is to be determined, be situated in the overlap region of at least two radar sensors. In this context, the area in which an object can be detected by a radar sensor, depends on the so-called “radar cross-section” (RCS), which can be described as the reflectivity of an object for radar waves.

However, there are some disadvantages associated with the use of triangulation for determining precise positions: Inexact distance determinations greatly affect the values ascertained for the angle and, thus, for the position. To minimize this error, the radar sensors would have to be positioned at a distance from one another that is on the order of magnitude of the distance of the sensed object from the vehicle. However, this is not feasible in a vehicle application, since the maximum distance between the radar sensors is limited by the width of the vehicle.

Furthermore, a necessary assumption of the triangulation method is that the objects in the typical automobile surroundings are small or punctiform. This is no longer a reasonable assumption, since the objects being considered are more likely to have sizable dimensions (other vehicles, trucks, pedestrians).

Moreover, there is the risk when applying the triangulation method, that two objects, which are each at the same distance from a radar sensor, are interpreted as one single object, which is then erroneously localized between the two real objects (so-called ghost target).

To overcome some of the drawbacks discussed above, the German Application DE 199 49 409 A1 proposes observing the time characteristic of the positions of the sensed objects (so-called tracking). However, the method proposed in the mentioned publication entails substantial computational expenditure and, thus, an unacceptable processing time, particularly for time-critical applications, such as precrash sensor analysis.

Moreover, a tracking method yields usable results only in the context of an approximately constant motion of the objects being tracked, without too great dynamic changes occurring. It is precisely in critical driving situations, where reliable detection of objects in the relatively near vehicle surroundings is of decisive importance, that extremely dynamic action and, thus, qualitatively inferior results of a tracking method are to be expected.

### SUMMARY OF THE INVENTION

An object of the present invention is, therefore, to provide a device and a method which will ensure a reliable and rapid detection of objects in the vehicle surroundings.

In accordance with the method of the present invention for sensing objects in the areas surrounding vehicles, positional information pertaining to the objects in the vehicle surroundings is derived on the basis of a comparison of input values, supplied by sensors, with data sets stored in a memory unit. The input values include distance data and Doppler velocities, for example. Doppler velocities are the velocities of an object in relation to a sensor that are ascertained by the sensor itself from a Doppler measurement, and output by the sensor. The data stored in the memory unit are reference data sets which represent the objects in a defined spatial region in the vehicle surround, with their exact positions. To precisely determine the position of an object detected by the sensors, the input values supplied by the sensors are compared within the framework of a classification, to the reference data sets. On the basis of the thus determined position of the object in relation to the vehicle, a decision may be made as to whether a sensed object is located within an area in which a collision with the object is to be expected; in particular, it is possible to differentiate between an obstacle that is expected to be passed by or one that is expected to be hit.

The method is continuously repeated in successive measuring cycles, at selectable intervals.

Various advantages are derived from the classification, such as a high recognition rate, i.e., real objects in the vehicle surroundings are reliably detected. In this context, objects rapidly approaching one side of the vehicle are also reliably detected.

Moreover, by doing without tracking algorithms, the positional determination in accordance with the method of the present invention is able to be carried out much more rapidly than would be possible using a tracking method.

The computational expenditure associated with the conventional methods, such as triangulation or tracking, increases considerably with the number of sensors used. In contrast, the use of a plurality of sensors in conjunction with a classification, entails an only slight increase in computational expenditure, since, for the most part, a classification is a comparison of data sets that is able to be quickly performed.

In addition, the method according to the present invention enables punctiform, as well as sizable, and weakly reflecting objects, such as pedestrians, to be detected with adequate certainty.

Typically, the input values supplied by the sensors merely provide information on recognized targets along with their particular distances and velocities, without allocating recognized targets to real objects. In one first advantageous variant of the present invention, real objects in the vehicle surroundings are ascertained from these input values, and their distance data are determined. In the process, it is also advantageous to consider the velocity values of the detected targets, furnished by the sensors; on the one hand, this makes it possible to improve the recognition of relevant objects and, on the other hand, to suppress errors resulting, for example, from distance measurements made by various sensors to different objects being erroneously interpreted as measurements to one single object (so-called ghost targets).

Moreover, it is beneficial to correct any signal dropouts in the measured values by averaging preceding and subsequent values. In this context, the number of values to be considered (the so-called filter mask) may be variably selected. This clearly improves the quality of the data to be processed and thus the recognition rate of relevant objects.

Another advantageous refinement of the method according to the present invention provides for determining the relative velocities between the sensed objects and the vehicle. The thus obtained relative velocities may be utilized when applying the method according to the present invention, as input information for a precrash sensor system, in order to predict a potentially imminent collision with an object and, if indicated, to initiate appropriate countermeasures.

The relative velocities may be determined in two ways.

A first possibility for calculating the relative velocity provides for analyzing the successively measured distance data to an object. To this end, for example, the distance data stored at a specific point in time in the FIFO (first in—first out memory) of a sensor are analyzed, and the relative velocities obtained in this manner for this point in time are averaged. In a subsequent step, the average value of the thus obtained, averaged relative velocities is formed for a specific, defined time period. The relative velocities obtained in this manner are stored in another FIFO.

An alternative to this manner of determining the relative velocity provides for first reading out the Doppler velocities for an object measured by the sensors. These Doppler velocities are averaged for a specific period of time and the thus obtained average values for the considered periods of time are stored in an FIFO memory.

In accordance with one advantageous refinement of the method of the present invention, on the basis of the quantities ascertained by the sensors, a delimited region is defined in the vehicle surroundings in which the objects to be considered are situated.

For this purpose, the so-called “critical distance” is initially defined. It depends on the calculated relative velocity between an object and the vehicle, the early-warning time for the safety-related components of the vehicle, as well as on the update rate of the input values, and is used as a basis for calculating the region to be considered.

To calculate the region being considered, for example in front of a vehicle, the following method steps are carried out in particular:

When the smallest measured distance min(rⱼᵢ) is smaller than the critical distance, then the upper threshold of the region to be considered is defined as min(rⱼᵢ), otherwise the process is terminated—no object is situated within the critical distance. In this context, rⱼᵢ is the distance of sensor j from object i.

The lower threshold of the region to be considered is derived from the crossings of the circles of radii rⱼᵢ with the defined, lateral limits of the area to be considered. In the case that the area considered is an area in front of a vehicle, then the lateral limits essentially correspond to those lines which define the width of the vehicle.

When the thus ascertained lower threshold is below a specific minimum threshold, then this minimum threshold is defined as the lower threshold. The minimum threshold may correspond, for example, to the smallest measurable distance of the sensors.

Defining the region to be considered makes it advantageously possible to distinguish between the relevant and irrelevant objects sensed by the sensors. It is thus ensured that no computational time is used to calculate the precise position of irrelevant objects and that the full capacity of a processor that is used may be used to determine the precise position of relevant objects.

Moreover, it is advantageous to take precautions for cases when it is not possible to ascertain any positional data using the classification procedure. In such cases, the result of the classification reads “ZERO”. If the classification yields the result “ZERO” multiple times in succession, then the last valid result is maintained for an adjustable number of measuring cycles. However, this result is only output when the number of same or similar results of the preceding measuring cycles exceeds a number that is settable in advance. It is thus ensured that a correct result is output and not, for instance, the result of an already erroneous last measurement.

The described method may be advantageously implemented by a device, which may be installed as original equipment in vehicles or offered as a supplementary-equipment set. The device according to the present invention has a plurality of sensors, as well as an analyzing unit, for example a processor integrated in the vehicle having inputs and outputs, as well as a memory unit. The classification and thus the exact positional determination of the relevant objects is undertaken by the processor on the basis of a comparison with reference data sets stored in the memory unit. The device according to the present invention may be used both in the front-end section, as well as in the rear section of a vehicle.

In this context, radar sensors, for example, constitute an advantageous choice for the sensors. This class of sensors supplies high-quality data even under the most diversified weather and illumination conditions. In the meantime, suitable radar sensors have become commercially available at reasonable prices; they are offered by the firm M/A-COM, for example. Optical sensors may be used as an alternative to radar sensors or to supplement the same. In this case, so-called closing velocity sensors (CV) offer some advantages.

A CV sensor emits coded laser light which is reflected by objects in the sensing range. From the reflected signal, information can be derived on the distance and state of motion of an object, similarly to the manner in which information is obtained from a radar signal. Besides these primary functions, other possible uses arise from the power spectrum of the sensor. Thus, for example, it is conceivable to use the CV sensor as a rain or road-condition sensor.

To enhance the safety of operation of the device, it is beneficial to provide additional means to monitor the reliability performance of the sensors, i.e., detect a possible sensor failure and warn the driver, i.e., deactivate the device, to prevent false activation.

### BRIEF DESCRIPTION OF THE DRAWINGS

One possible embodiment of the present invention is explained in detail in the following with reference to the drawings, whose figures show:

FIG. 1 a block diagram of the method according to the present invention;

FIG. 2 a detailed representation of the geometrical relationships in the area being considered for a classification.

### DETAILED DESCRIPTION

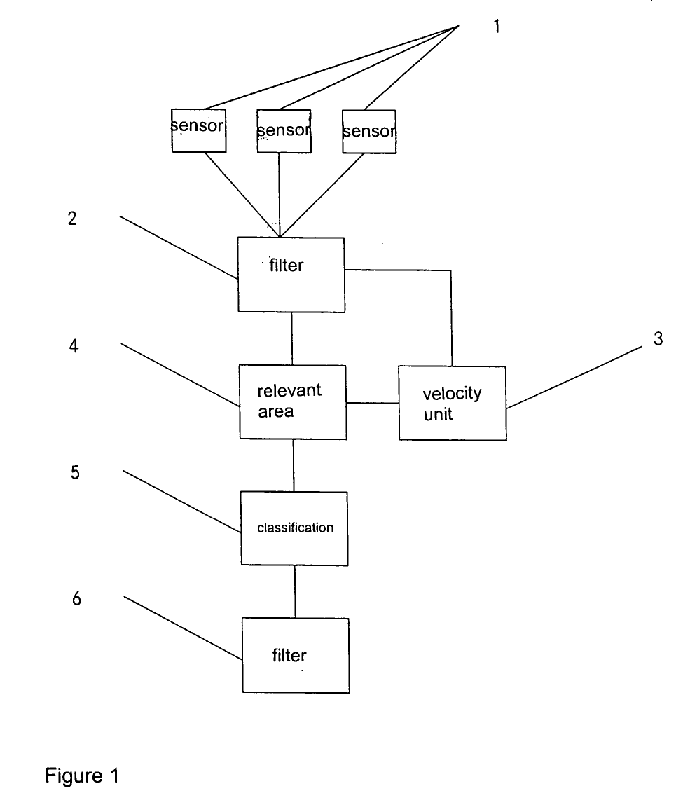

FIG. 1 shows a block diagram, to clarify the functioning of a device in which the method according to the present invention may be implemented. Within their sensing range, sensors 1 determine distances and relative velocities of objects and transmit the same to input filter 2. In this context, input filter 2 is used, on the one hand, to equalize any signal drop-outs in the sensor data in an averaging operation over a plurality of measuring cycles, and, on the other hand, on the basis of the distances measured by the sensors, and the velocities, to generate target lists containing the individual target objects identified in the sensing range of the sensor, and to make it possible to differentiate among various objects. The information acquired in input filter 2 is subsequently fed to the unit for calculating relative velocity 3. In this unit, on the basis of the information acquired from input filter 2, the relative velocities between the detected objects and the vehicle are determined. Together with the distance values, which are determined for the individual objects by input filter 2, this information is further processed in the downstream unit to determine relevant area 4. Here, it is established in accordance with the above described method, which objects are to be considered as relevant and should thus be the subject of subsequent classification 5. An important result of classification 5 is the determination of the exact positions of relevant objects in front of the vehicle. This is accomplished on the basis of a comparison of the measured values with reference values stored in a database, and by selecting the data set which yields the fewest deviations from the data set determined on the basis of the measurements.

In the last step of the method, any error measurements are corrected or suppressed by output filter 6 in that output filter 6 maintains plausible results from the preceding measuring cycles.

The partitioning of tasks into individual components, selected in the exemplary embodiment presented here, is to be viewed as an exemplary realization; it is, of course, likewise possible to combine parts of the method into functional units, in a software implementation, for example.

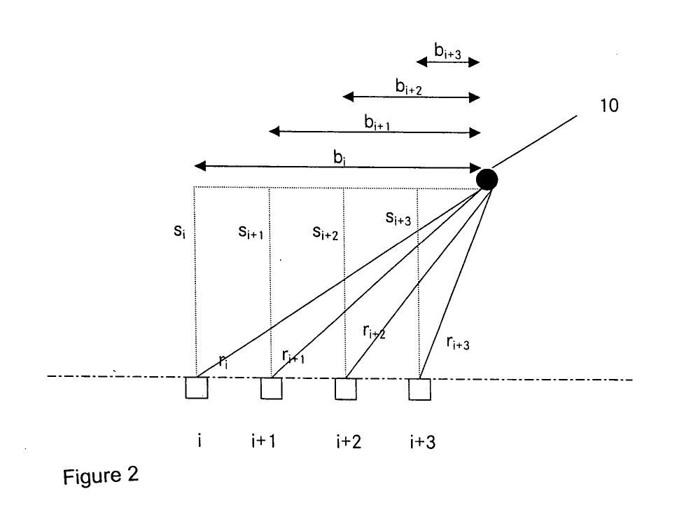

Classification 5 is explained in greater detail on the basis of subsequent FIG. 2. The distance of an object from the front of vehicle sᵢ, its lateral offset from sensor bᵢ, as well as distance rᵢ of the object from sensor i, form a right-angled triangle. Thus it holds that:
ᵢ²=rᵢ²−Sᵢ²

In the following, the determination of the exact position of an individual object 10 is considered: For object 10 having known distance rᵢ to sensor i, individual bᵢ are successively determined for different Sᵢ, which are within the delimited region in the vehicle surroundings. In the process, Sᵢ is progressively varied within the limits obtained from the determination of the area to be considered. The thus obtained sets of bᵢ for sensor i may be considered as components of a vector. This procedure is repeated for all sensors i. At this point, the thus obtained vectors are compared in a subsequent step to reference vectors stored in the database. To determine lateral offset b of object 10 in front of the vehicle, that vector is selected from the database which deviates the least from the vector determined from the measured data. Lateral offset b of object 10 in front of the vehicle may be quickly determined in this manner. In the process, the speed of the classification may be optimized by suitably selecting the step size for Sᵢ.

1. A method for sensing objects in the surrounding of a vehicle, comprising the steps of:
determining input values with respect to the objects by a plurality of sensors; and
deriving positional information pertaining to the objects from the input values on the basis of a comparison with stored data.

2. The method as recited in claim 1 wherein the sensors are radar sensors.

3. The method as recited in claim 1 further comprising in an additional step of determining the distances to the objects from the input values supplied by the sensors.

4. The method as recited in claim 3 further comprising suppressing errors in the input values.

5. The method as recited in claim 1 further comprising determining relative velocities between the objects and the vehicle.

6. The method as recited in claim 5 wherein the relative velocities are determined from successively measured distance data on the objects.

7. The method as recited in claim 5 wherein the relative velocities are determined from a Doppler measurement.

8. The method as recited in claim 1 further comprising defining a region in the vehicle surroundings to be considered.

9. The method as recited in claim 1 wherein stored positional data from preceding measurements are substituted as the stored data when the positional information temporarily is not derivable.

10. A device for sensing objects in the surrounding field of vehicles, comprising:
a plurality of sensors; and
an analyzing unit having a classification device for deriving positional information on the objects on the basis of a comparison with data stored in a memory unit.

11. The device as recited in claim 10 wherein the sensors are radar sensors, optical sensors, or a combination of radar sensors and optical sensors.

12. The device as recited in claim 10 wherein the analyzing unit or another device is capable of recognizing failure of a sensor of the plurality of sensors.
